(19) United States
(12) Patent Application Publication
(10) Pub. No.: US 2022/0317238 A1
(43) Pub. Date: Oct. 6, 2022

(54) VESSEL ANALYSIS DEVICE, VESSEL BEHAVIOR LEARNING DEVICE, VESSEL ANALYSIS SYSTEM, VESSEL ANALYSIS METHOD, VESSEL BEHAVIOR LEARNING METHOD, AND RECORDING MEDIUM

(71) Applicant: NEC Corporation, Minato-ku, Tokyo (JP)

(72) Inventor: Kenta SENZAKI, Tokyo (JP)

(73) Assignee: NEC Corporation, Minato-ku, Tokyo (JP)

(21) Appl. No.: 17/425,829

(22) PCT Filed: Feb. 1, 2019
(86) PCT No.: PCT/JP2019/003664

§ 371 Date: Jul. 26, 2021

(51) Int. Cl. G01S 5/06; G08G 3/00; G01S 5/02

(52) U.S. Cl. CPC G01S 5/06; G08G 3/00; G01S 5/0257; G01S 5/0294

(57) ABSTRACT

A vessel analysis device capable of appropriately determining a suspicious vessel is provided. The vessel analysis device (1) includes a pattern generation unit (2), an estimation unit (4), and a determination unit (6). The pattern generation unit (2) generates an intended track pattern representing a track of an intended vessel that is a vessel to be analyzed, from position information on the intended vessel, the position information changing as time proceeds. The estimation unit (4) estimates the navigation state of the intended vessel using the generated track pattern. The determination unit (6) determines whether an intended navigation state that is a navigation state indicated in vessel information originated by the intended vessel is falsified or not by comparing the estimated navigation state with the intended navigation state.

### TECHNICAL FIELD

The present invention relates to a vessel analysis device, a vessel behavior learning device, a vessel analysis system, a vessel analysis method, a vessel behavior learning method, and a recording medium.

### BACKGROUND ART

For the sake of preventing annoying actions and smuggling by suspicious vessels, visual vessel monitoring has been conducted. On the other hand, in recent years, a technique of supporting visual monitoring using vessel information and the like from radars and vessel automatic identification systems (AIS: Automatic Identification Systems) has been disclosed. For example, Patent Literature 1 discloses a system that includes one or more vessel automatic identification system (AIS) receivers configured to observe, geolocate, and receive vessel automatic identification system (AIS) emissions from one or more vessels to detect vessel automatic identification system (AIS) signatures.

### CITATION LIST

### Patent Literature

### Patent Literature 1

Japanese Unexamined Patent Application Publication No. 2017-191593

### SUMMARY OF INVENTION

### Technical Problem

AIS vessel information (AIS information) can be intentionally faked (falsified). Consequently, according to the technique that simply observes AIS emissions, identifies the positions, and detects AIS signatures as in Patent Literature 1 described above, there is a possibility that the navigation states of vessels cannot appropriately be analyzed. Therefore, there is a possibility that a suspicious vessel cannot appropriately be determined.

The present disclosure has been made in order to solve such a problem, and has an object to provide a vessel analysis device, a vessel behavior learning device, a vessel analysis system, a vessel analysis method, a vessel behavior learning method, and a recording medium that are capable of appropriately determining a suspicious vessel.

### Solution to Problem

A vessel analysis device according to the present disclosure includes: pattern generation means for generating an intended track pattern representing a track of an intended vessel that is a vessel to be analyzed, from position information on the intended vessel, the position information changing as time proceeds; estimation means for estimating a navigation state of the intended vessel, using the generated track pattern; and determination means for determining whether an intended navigation state that is a navigation state indicated in vessel information originated by the intended vessel is falsified or not by comparing the estimated navigation state with the intended navigation state.

A vessel behavior learning device according to the present disclosure includes: pattern generation means for generating a plurality of track patterns representing tracks of one or more vessels, from position information on the vessels, using vessel information originated from the vessels, the position information changing as time proceeds; and pattern learning means for generating learned parameters by machine learning using the generated track patterns and correct navigation states that are correct labels corresponding to the respective track patterns.

A vessel analysis system according to the present disclosure includes: vessel analysis means for analyzing a behavior of a vessel; and vessel behavior learning means for generating learned parameters used by the vessel analysis means, wherein the vessel behavior learning means includes: first pattern generation means for generating a plurality of track patterns representing tracks of one or more vessels, from position information on the vessels, using vessel information originated from the vessels, the position information changing as time proceeds; and pattern learning means for generating the learned parameters by machine learning using the track patterns generated by the first pattern generation means, and correct navigation states that are correct labels corresponding to the respective track patterns, and the vessel analysis means includes: second pattern generation means for generating an intended track pattern representing a track of an intended vessel that is a vessel to be analyzed, from position information on the intended vessel, the position information changing as time proceeds; estimation means for estimating a navigation state of the intended vessel, using the intended track pattern generated by the second pattern generation means, and the learned parameters; and determination means for determining whether an intended navigation state that is a navigation state indicated in vessel information originated by the intended vessel is falsified or not by comparing the estimated navigation state with the intended navigation state.

A vessel analysis method according to the present disclosure includes: generating an intended track pattern representing a track of an intended vessel that is a vessel to be analyzed, from position information on the intended vessel, the position information changing as time proceeds; estimating a navigation state of the intended vessel, using the generated track pattern; and determining whether an intended navigation state that is a navigation state indicated in vessel information originated by the intended vessel is falsified or not by comparing the estimated navigation state with the intended navigation state.

A vessel behavior learning method according to the present disclosure includes: generating a plurality of track patterns representing tracks of one or more vessels, from position information on the vessels, using vessel information originated from the vessels, the position information changing as time proceeds; and generating learned parameters by machine learning using the generated track patterns and correct navigation states that are correct labels corresponding to the respective track patterns.

A program according to the present disclosure causes a computer to execute: a step of generating an intended track pattern representing a track of an intended vessel that is a vessel to be analyzed, from position information on the intended vessel, the position information changing as time proceeds; a step of estimating a navigation state of the intended vessel, using the generated track pattern; and a step of determining whether an intended navigation state that is a navigation state indicated in vessel information originated by the intended vessel is falsified or not by comparing the estimated navigation state with the intended navigation state.

A program according to the present disclosure causes a computer to execute: a step of generating a plurality of track patterns representing tracks of one or more vessels, from position information on the vessels, using vessel information originated from the vessels, the position information changing as time proceeds; and a step of generating learned parameters by machine learning using the generated track patterns and correct navigation states that are correct labels corresponding to the respective track patterns.

The present disclosure can provide the vessel analysis device, the vessel behavior learning device, the vessel analysis system, the vessel analysis method, the vessel behavior learning method, and the recording medium that are capable of appropriately determining a suspicious vessel.

### BRIEF DESCRIPTION OF THE DRAWINGS

FIG. 1 is a diagram showing an overview of a vessel analysis device according to example embodiments of the present disclosure.

FIG. 2 shows a vessel analysis system according to a first example embodiment.

FIG. 3 shows a configuration of a vessel behavior learning device according to the first example embodiment.

FIG. 4 is a flowchart showing a vessel behavior learning method executed by the vessel behavior learning device according to the first example embodiment.

FIG. 5 is a diagram for illustrating a track pattern generation method according to the first example embodiment.

FIG. 6 is a diagram for illustrating the track pattern generation method according to the first example embodiment.

FIG. 7 is a diagram for illustrating the track pattern generation method according to the first example embodiment.

FIG. 8 shows a configuration of a vessel analysis device according to the first example embodiment.

FIG. 9 is a flowchart showing a vessel analysis method executed by the vessel analysis device according to the first example embodiment.

FIG. 10 shows a configuration of a vessel behavior learning device according to a second example embodiment.

FIG. 11 shows a configuration of a vessel analysis device according to the second example embodiment.

FIG. 12 shows a configuration of a vessel behavior learning device according to a third example embodiment.

FIG. 13 shows a configuration of a vessel analysis device according to the third example embodiment.

### DESCRIPTION OF EMBODIMENTS

### (Overview of Example Embodiments According to Present Disclosure)

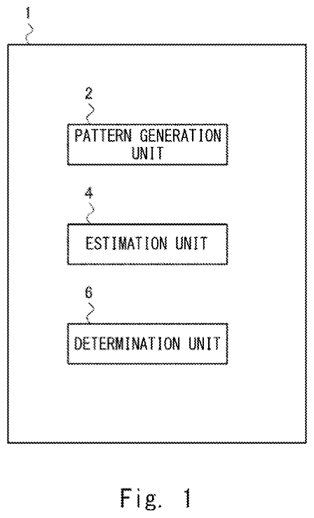

Prior to description of example embodiments of the present disclosure, an overview of the example embodiments according to the present disclosure is described. FIG. 1 is a diagram showing an overview of a vessel analysis device 1 according to example embodiments of the present disclosure. The vessel analysis device 1 is, for example, a computer. The vessel analysis device 1 analyzes the behavior of a vessel (i.e., marine vessel). The vessel analysis device 1 includes a pattern generation unit 2, an estimation unit 4, and a determination unit 6. The pattern generation unit 2 functions as pattern generation means (second pattern generation means). The estimation unit 4 functions as estimation means. The determination unit 6 functions as determination means.

The pattern generation unit 2 generates an intended track pattern representing a track of an intended vessel that is a vessel to be analyzed, from position information on the intended vessel, the position information changing as time proceeds. The intended track pattern (track pattern) is, for example, an image. The estimation unit 4 estimates the navigation state of the intended vessel using the generated track pattern. The determination unit 6 determines whether an intended navigation state that is a navigation state indicated in vessel information originated by the intended vessel is falsified or not by comparing the estimated navigation state with the intended navigation state. Hereinafter, problems about the related art are described.

In recent years, destruction of environment and depletion of resources due to illegal fishing have been considered problematic worldwide. To prevent illegal fishing, a vessel automatic identification systems (AIS) that mutually communicate information (vessel information), such as on identification symbols, types, positions, courses, velocities, and navigation states of vessels, between vessels and with ground base stations have attracted attention. AIS data indicating the navigation state includes a code indicating a state in fishing operation. Accordingly, through correct operation of AIS, it is expected to grasp fishing operations of individual vessels and, in turn, to grasp actual situations of fishing over the entire marine area.

Here, typically, AIS mounted on vessels are classified into two types that are Class A and Class B. In many cases, AIS mounted on fishing vessels are of inexpensive Class B without a function of transmitting navigation states. Even if the number of fishing vessels mounted with Class A systems increases, AIS navigation states are manually input by sailors. Accordingly, there is a problem in that malicious falsification can be easily made.

Against such a problem, a method of extracting incorrect inputs of navigation states through an expert system based on domain knowledge has been proposed. This method compares information on the navigation state included in AIS with other navigation-related information, and extracts a combination estimated to hardly occur, as an incorrect input. For example, a certain velocity or higher cannot be recorded in a “moored” or “anchored” state without movement. Accordingly, in case AIS data with two or more knots includes an input of a navigation state indicating “moored” or “anchored”, the input is extracted as incorrect input data.

On the other hand, there are 16 navigation states defined about AIS at the maximum. Accordingly, based on the method described above, it is complicated to construct an expert system that encompasses all the states. In particular, for a navigation state “fishing”, various fishing types are required to be supported. That is, there has been a problem of stably extracting incorrect input data from various navigation states encompassing various fishing types on the basis of AIS information.

To address such problems, the vessel analysis device 1 according to the present disclosure is configured as described above. Accordingly, it can be appropriately determined whether a navigation state indicated by vessel information (e.g., AIS information) originated from an intended vessel is falsified or not. Consequently, incorrect input data can be stably extracted from various navigation states encompassing various fishing types on the basis of AIS information. Therefore, the vessel analysis device 1 according to the present disclosure can appropriately determine a suspicious vessel.

### First Example Embodiment

Example embodiments are hereinafter described with reference to the drawings. To clarify the illustration, items of the following description and drawings are appropriately omitted and simplified. In each drawing, the same elements are assigned the same symbols, and redundant description is omitted as required.

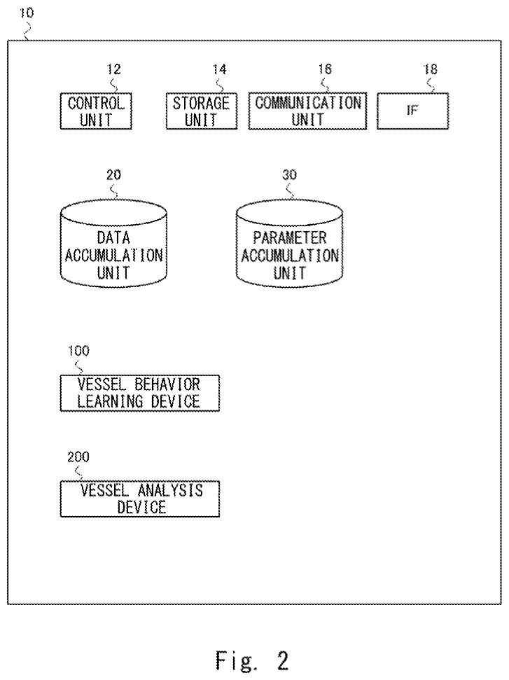

FIG. 2 shows a vessel analysis system 10 according to a first example embodiment. The vessel analysis system 10 includes, as main hardware components: a control unit 12; a storage unit 14; a communication unit 16; and an interface unit 18 (IF). The control unit 12, the storage unit 14, the communication unit 16, and the interface unit 18 are connected to each other via a data bus and the like.

The control unit 12 is, for example, a processor, such as a CPU (Central Processing Unit). The control unit 12 has a function as a computation device that performs a control process, a computation process and the like. The storage unit 14 is, for example, a storage device, such as a memory or a hard disk. The storage unit 14 is, for example, a ROM (Read Only Memory), a RAM (Random Access Memory) or the like. The storage unit 14 has a function for storing a control program, a computational program and the like executed by the control unit 12. The storage unit 14 has a function for temporarily storing data to be processed and the like. The storage unit 14 may include a database.

The communication unit 16 performs processes required to communicate with other devices. The communication unit 16 may include a communication port, a router, and a firewall. The interface unit 18 (IF) is, for example, a user interface (UI). The interface unit 18 includes: an input device, such as a keyboard, a touch panel or a mouse; and an output device, such as a display or a speaker. The interface unit 18 accepts an operation of inputting data by a user (operator), and outputs information to the user. The interface unit 18 may display an analysis result about a vessel to be analyzed.

The vessel analysis system 10 according to the first example embodiment includes a data accumulation unit 20, a parameter accumulation unit 30, a vessel behavior learning device 100, and a vessel analysis device 200. The data accumulation unit 20, the parameter accumulation unit 30, the vessel behavior learning device 100, and the vessel analysis device 200 respectively function as data accumulation means, parameter accumulation means, vessel behavior learning means, and vessel analysis means.

Note that each configuration element of the vessel analysis system 10 can be achieved by executing a program under control of the control unit 12, for example. More specifically, each configuration element may be achieved by the control unit 12 executing a program stored in the storage unit 14. A required program may be preliminarily recorded in any nonvolatile recording medium, and be installed as required, thereby achieving each configuration element. Each configuration element is not necessarily achieved by software by means of a program, and may be achieved by a combination of any of hardware, firmware, and software. Each configuration element may be achieved using an integrated circuit, for example, an FPGA (field-programmable gate array) or a microcomputer, which can be programmed by the user. In this case, the program configured by each configuration element described above can be achieved using the integrated circuit. The above description similarly applies to other example embodiments described later. Note that specific functions of individual configuration elements are described later.

The vessel behavior learning device 100 and the vessel analysis device 200 may be physically separate devices. In this case, both the vessel behavior learning device 100 and the vessel analysis device 200 may separately include the control unit 12, the storage unit 14, the communication unit 16, and the interface unit 18. In this case, both the vessel behavior learning device 100 and the vessel analysis device 200 can each independently execute programs. In an opposite manner, individual configuration elements (described later) of the vessel behavior learning device 100 and the vessel analysis device 200 may be configured in a physically integrated device. In this case, in the vessel analysis system 10, the individual configuration elements of the vessel behavior learning device 100 and the vessel analysis device 200 are not necessarily physically separated from each other.

The data accumulation unit 20 is a database that may be achieved by the storage unit 14. More specifically, the data accumulation unit 20 can be achieved by storage media, such as a hard disk and a memory card, which store pieces of vessel information on many vessels, or by a network in which they are connected to each other. The data accumulation unit 20 accumulates or transmits the vessel information on the vessels. The vessel information has been obtained through AIS, for example, but is not limited to such a configuration.

The vessel behavior learning device 100 generates a plurality of track patterns that represent tracks of vessels, from the vessel information stored in the data accumulation unit 20. The vessel behavior learning device 100 generates learned parameters from the plurality of track patterns through machine learning, and stores the parameters in the parameter accumulation unit 30.

The parameter accumulation unit 30 may be achieved by the storage unit 14. More specifically, the parameter accumulation unit 30 can be achieved by storage media, such as a hard disk and a memory card, which store parameters (learned parameters) of a vessel behavior classifier generated by the vessel behavior learning device 100, or by a network in which they are connected to each other. The parameter accumulation unit 30 accumulates or transmits the learned parameters.

The vessel analysis device 200 functions as a navigation state true-false determination device that determines true or false of the navigation state indicated by the vessel information on an intended vessel. The vessel analysis device 200 generates an intended track pattern that indicates the track of the intended vessel. The vessel analysis device 200 estimates the navigation state of the intended vessel using the learned parameters from the generated track pattern. The vessel analysis device 200 then determines whether an intended navigation state that is a navigation state indicated in vessel information originated by the intended vessel is falsified or not by comparing the estimated navigation state with the intended navigation state.

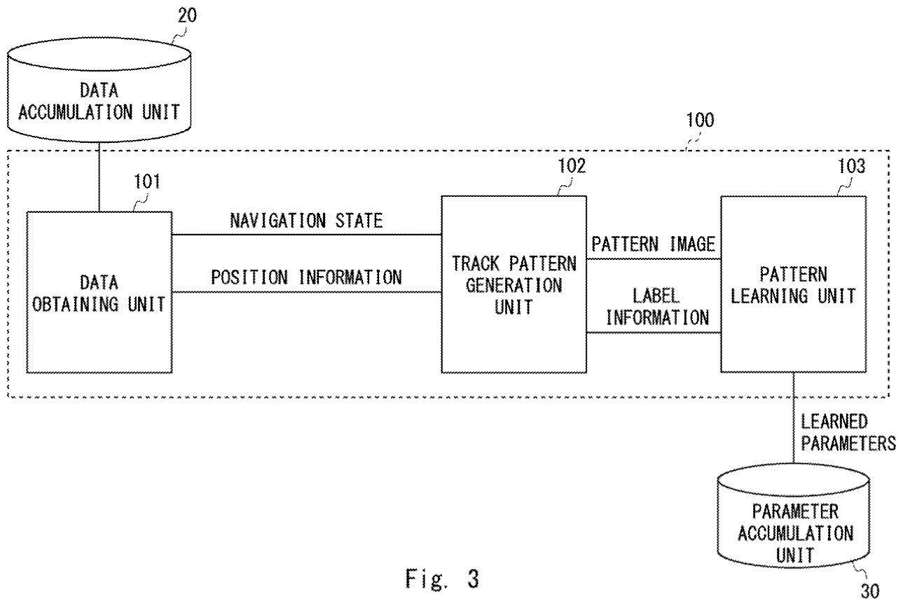

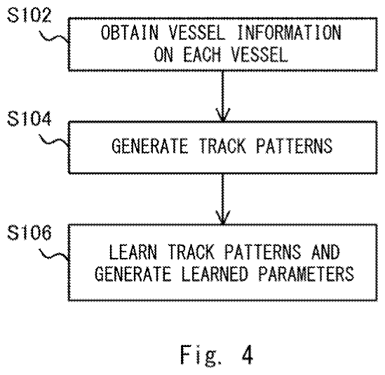

FIG. 3 shows the configuration of the vessel behavior learning device 100 according to the first example embodiment. FIG. 4 is a flowchart showing a vessel behavior learning method executed by the vessel behavior learning device 100 according to the first example embodiment. The vessel behavior learning device 100 according to the first example embodiment includes a data obtaining unit 101, a track pattern generation unit 102, and a pattern learning unit 103. The data obtaining unit 101 functions as data obtaining means. The track pattern generation unit 102 functions as track pattern generation means (first pattern generation means). The pattern learning unit 103 functions as pattern learning means.

The data obtaining unit 101 obtains vessel information on each vessel (step S102). Here, in the data accumulation unit 20, vessel information on a plurality of vessels are accumulated. The vessel information is stored in the data accumulation unit 20 in a state where the navigation state of and time information on the corresponding vessel are associated with each other. The data obtaining unit 101 extracts temporally continuous data items on navigation states of and pieces of position information on each vessel, from the data accumulation unit 20. The data obtaining unit 101 outputs the data indicating the navigation states and the position information to the track pattern generation unit 102. It is herein assumed that the navigation states obtained (extracted) in the process of S102 are not falsified (faked).

The track pattern generation unit 102 generates the track pattern for each piece of the vessel information, using the position information on the vessel (step S104). Specifically, the track pattern generation unit 102 generates a track pattern image that is drawn by interpolating discrete pieces of position information on the basis of the position information output from the data obtaining unit 101. The track pattern generation unit 102 then sets a navigation state (correct navigation state) corresponding to the track pattern image as a correct label of the track pattern, in the data on the navigation states obtained from the data obtaining unit 101. The track pattern generation unit 102 then outputs the generated track pattern image, and label information indicating the correct label, to the pattern learning unit 103. A more specific method of generating the track pattern is described later.

The pattern learning unit 103 learns the track patterns, and generates learned parameters (step S106). Specifically, the pattern learning unit 103 learns the track pattern image, on the basis of the track pattern image and the label information output from the track pattern generation unit 102, optimizes the parameters of the navigation state classifier, and generates the learned parameters. The pattern learning unit 103 then stores the optimized parameters (learned parameters) in the parameter accumulation unit 30.

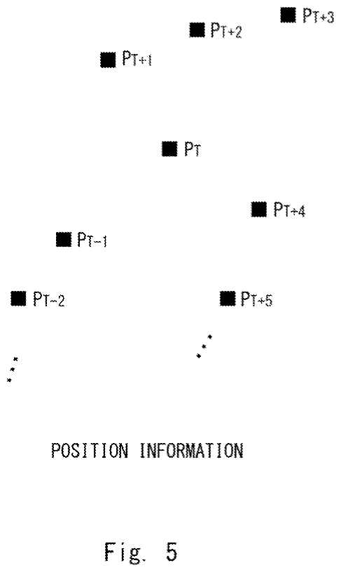

FIGS. 5 to 7 are diagrams for illustrating the track pattern generation method according to the first example embodiment. The vessel information includes a plurality of datasets that have been sampled at predetermined time intervals and are continuous in a time-series manner. The dataset at a time point i includes position information pᵢ, velocity information vᵢ, and a navigation state si. The track pattern generation unit 102 selects one data item at any time point serving as a reference from among the datasets. The reference time point is herein assumed as T.

The position information pᵢ at the time point i is absolute position information, such as a latitude and a longitude. It is assumed the latitude is lngᵢ and the longitude is latᵢ, and pᵢ is represented by the following Equation 1.

$$\begin{matrix}[ Expression 1 ] & \\ {p}_{i} ( \begin{matrix}{lng}_{i} \\ {lat}_{i}\end{matrix} ) & ( Equation 1 )\end{matrix}$$

Each point is plotted, thus forming discrete points as shown in FIG. 5 as an example. In FIG. 5, pieces of the position information at time points T-2, . . . , T, . . . , T+5 are plotted. Note that a time point T+k (k is an integer) does not mean a time point that is k seconds after time point T, but means a k-th time point after the time point T in a sampling period.

Next, the track pattern generation unit 102 calculates relative position information pᵢ′ with respect to the reference time point T, for m data items before and after the reference time point T, by the following Equation 2. Here, round( ) represents rounding to an integer, and a is a predetermined scalar value.

(Equation 2)

pᵢ′=round(α×(pᵢ−p_{T})),i=T−m, . . . ,T, . . . ,T+m [Expression 2]

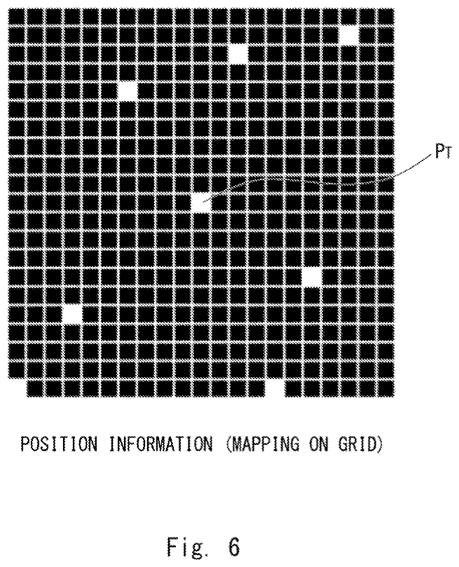

The track pattern generation unit 102 maps each pᵢ′ (position information) as shown in FIG. 6 as an example so as to position a point P_{T} at the reference time point T at the center of a grid having a predetermined size. Here, the resolution of one cell of the grid is assumed as r, and a described above is represented as α=1/r.

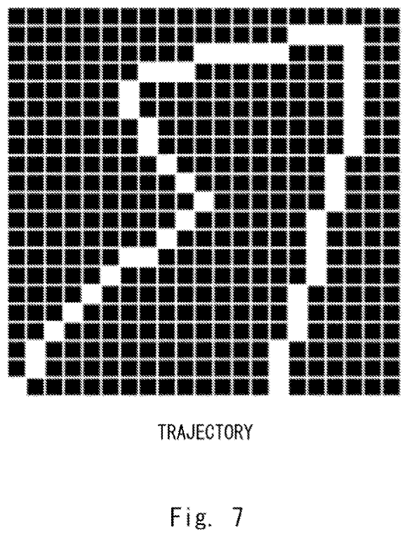

Next, the track pattern generation unit 102 connects temporally continuous points with straight lines, and generates the track pattern image as shown in FIG. 7 as an example. Note that for the sake of simplicity, the straight lines are used for connecting the temporally continuous points. However, the straight lines are not necessarily used. For example, spline interpolation or the like may be used to connect the temporally continuous points with curves. Note that if the time intervals of the data on the position information are not uniform, a process of uniformly aligning the time intervals of data on each vessel may be applied.

As described above, the track pattern generation unit 102 sets the navigation state s_{T} at the time point T as the correct label, for the navigation states corresponding to the track pattern image generated centered at the reference time point T. By repeating the processes described above for any vessel at any time point, a large amount of correctly labelled image datasets can be generated.

The pattern learning unit 103 generates learned parameters, using a typical supervised classifier, through supervised machine learning, from the large amount of correctly labelled image datasets generated by the track pattern generation unit 102. The pattern learning unit 103 may perform learning using, for example, convolutional neural network (CNN) or the like. Alternatively, this unit may use a machine learning algorithm other than CNN. This similarly applies to the other example embodiments.

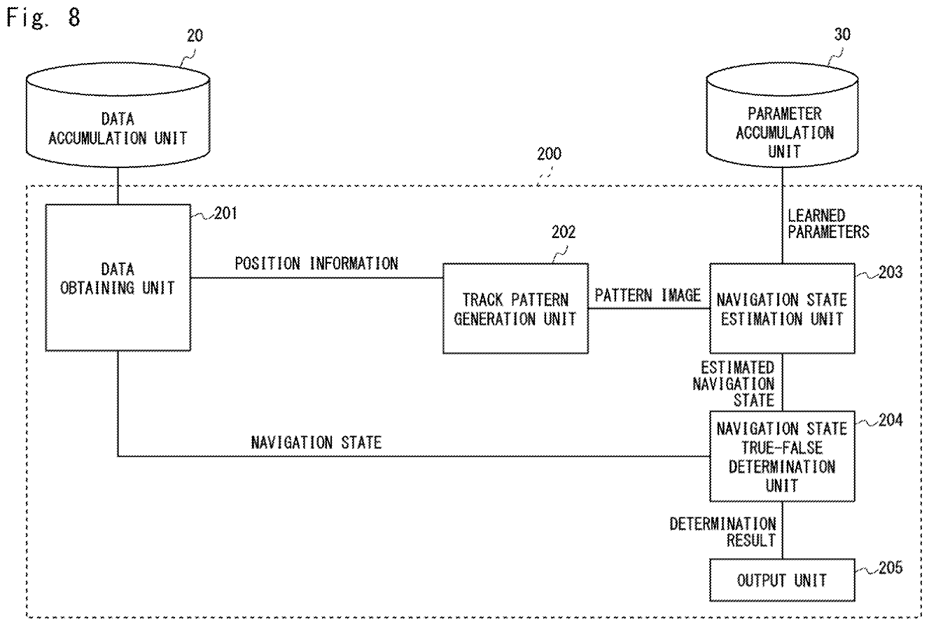

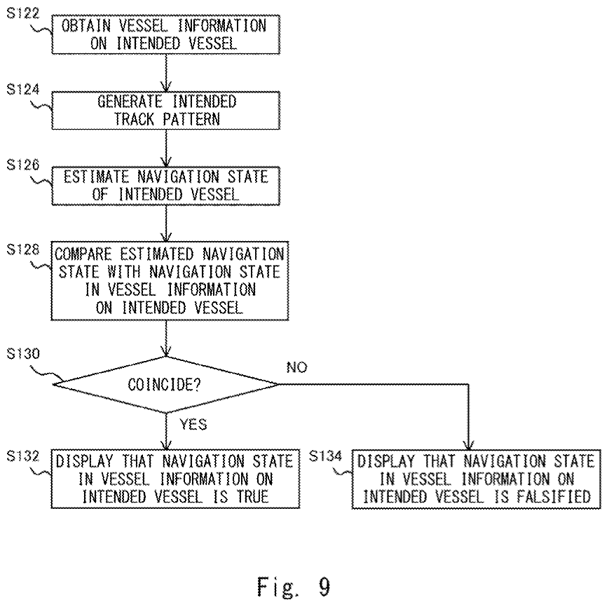

FIG. 8 shows the configuration of the vessel analysis device 200 according to the first example embodiment. FIG. 9 is a flowchart showing a vessel analysis method executed by the vessel analysis device 200 according to the first example embodiment. The vessel analysis device 200 includes a data obtaining unit 201, a track pattern generation unit 202, a navigation state estimation unit 203, a navigation state true-false determination unit 204, and an output unit 205. The data obtaining unit 201 functions as data obtaining means. The track pattern generation unit 202 functions as track pattern generation means (second pattern generation means). The navigation state estimation unit 203 functions as navigation state estimation means. The navigation state true-false determination unit 204 functions as navigation state true-false determination means. The output unit 205 functions as output means. The track pattern generation unit 202 corresponds to the pattern generation unit 2 shown in FIG. 1. The navigation state estimation unit 203 corresponds to the estimation unit 4 shown in FIG. 1. The navigation state true-false determination unit 204 corresponds to the determination unit 6 shown in FIG. 1.

The data obtaining unit 201 obtains the vessel information on an intended vessel (step S122). Specifically, the data obtaining unit 201 extracts data on temporally continuous navigation states of and pieces of position information on a vessel to be analyzed (intended vessel) from the data accumulation unit 20. The data obtaining unit 201 outputs the position information to the track pattern generation unit 202. The data obtaining unit 201 outputs data indicating the navigation state to the navigation state true-false determination unit 204. It is herein assumed that the navigation states obtained (extracted) in the process of S122 are possibly falsified (faked).

The track pattern generation unit 202 generates an intended track pattern that is a track pattern representing the track of the intended vessel (step S124). Specifically, the track pattern generation unit 202 generates a track pattern image (intended track pattern image) that is drawn by interpolating discrete pieces of position information on the basis of the position information output from the data obtaining unit 201. Note that the details of generation of the intended track pattern image is substantially similar to the process of the track pattern generation unit 102 (S104) except in that the process of setting the label corresponding to the track pattern is not included. Accordingly, the detailed description is omitted. The track pattern generation unit 202 then outputs the generated intended track pattern image to the navigation state estimation unit 203.

The navigation state estimation unit 203 estimates the navigation state of the intended vessel (step S126). Specifically, the navigation state estimation unit 203 obtains parameters of the navigation state classifier having already been learned (learned parameters) from the parameter accumulation unit 30. The navigation state estimation unit 203 uses the learned parameters to reconstruct a navigation state classifier having the same configuration as the navigation state classifier learned by the pattern learning unit 103. The navigation state estimation unit 203 estimates the navigation state of the intended vessel from the intended track pattern image output from the track pattern generation unit 202. The navigation state estimation unit 203 outputs the navigation state having been estimated (estimated navigation state) to the navigation state true-false determination unit 204.

The navigation state true-false determination unit 204 compares the navigation state (intended navigation state) indicated in the vessel information on the intended vessel output from the data obtaining unit 201 with the estimated navigation state output from the navigation state estimation unit 203 (step S128). The navigation state true-false determination unit 204 then determines whether the intended navigation state coincides with the estimated navigation state or not (step S130). If both the states coincide with each other (YES in S130), the navigation state true-false determination unit 204 outputs a signal indicating the coincidence (e.g., “0”) to the output unit 205. On the other hand, if these states do not coincide with each other (NO in S130), the navigation state true-false determination unit 204 outputs a signal indicating the non-coincidence (e.g., “1”) to the output unit 205.

The output unit 205 outputs the true-false determination result of the intended navigation state output from the navigation state true-false determination unit 204. The output described here encompasses displaying, recording, and transmitting of the determination result. The output unit 205 may be achieved by the interface unit 18 shown in FIG. 2. The output unit 205 may include a display device, a data output device (a printer etc.), and a storage device (or a storage medium). Alternatively, the output unit 205 may be configured to include a wired or wireless communication interface for connection with such a device. Note that the output unit 205 may include an output buffer that temporarily stores the determination result.

If the signal indicating the coincidence (e.g., “0”) is output from the navigation state true-false determination unit 204 (YES in S130), the output unit 205 displays that the intended navigation state is true (step S132). On the other hand, if the signal indicating the non-coincidence (e.g., “1”) is output from the navigation state true-false determination unit 204 (NO in S130), the output unit 205 displays that the intended navigation state is falsified (step S134).

As described above, the vessel analysis system 10 according to the first example embodiment learns, as a set, the track pattern generated from the position information in the vessel information, and the navigation state. During an actual operation, the vessel analysis system 10 according to the first example embodiment compares the navigation state estimated from the track pattern generated from the position information in the vessel information on the intended vessel, with the navigation state of the vessel information on the intended vessel, and determines whether the navigation state is true or false. Accordingly, without specialized knowledge, it can be appropriately determined whether the navigation state in the vessel information on the intended vessel is falsified or not. Consequently, the vessel analysis system 10 (vessel analysis device 200) according to the first example embodiment can appropriately determine a suspicious vessel. The vessel behavior learning device 100 of the vessel analysis system 10 according to the first example embodiment can generate learned parameters that can appropriately determine whether the navigation state in the vessel information on the intended vessel is falsified or not. Thus, the learned parameters that can appropriately determine a suspicious vessel can be generated.

### Second Example Embodiment

Next, a second example embodiment is described with reference to the drawings. To clarify the illustration, items of the following description and drawings are appropriately omitted and simplified. In each drawing, the same elements are assigned the same symbols, and redundant description is omitted as required. Note that the system configuration according to the second example embodiment is substantially similar to that shown in FIG. 2. Accordingly, the description is omitted. In the second example embodiment, the track pattern generation method is different from that in the first example embodiment.

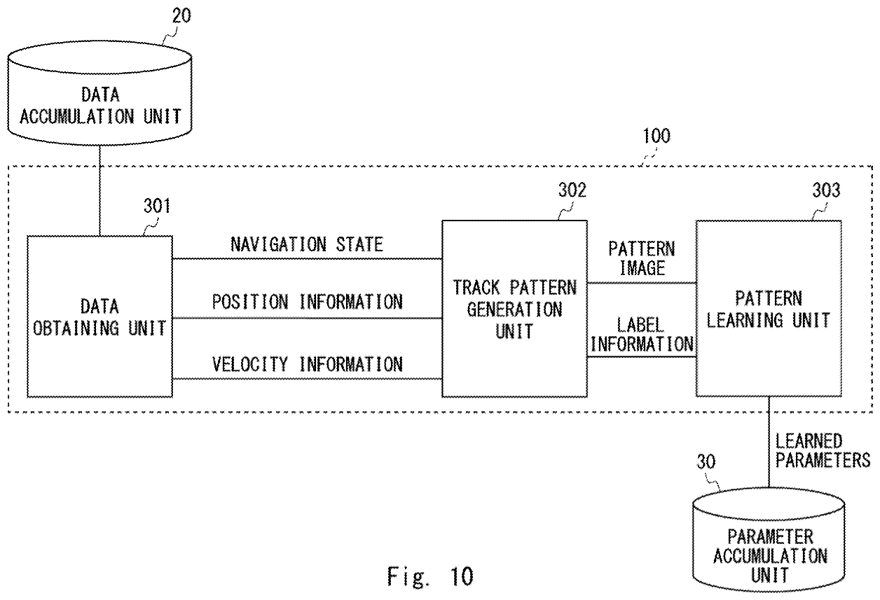

FIG. 10 shows the configuration of a vessel behavior learning device 100 according to the second example embodiment. Note that the overview of the vessel behavior learning method executed by the vessel behavior learning device 100 according to the second example embodiment is substantially similar to that in the flowchart shown in FIG. 4. The vessel behavior learning device 100 according to the second example embodiment includes a data obtaining unit 301, a track pattern generation unit 302, and a pattern learning unit 303. The data obtaining unit 301 functions as data obtaining means. The track pattern generation unit 302 functions as track pattern generation means (first pattern generation means). The pattern learning unit 303 functions as pattern learning means.

The data obtaining unit 301 obtains vessel information on each vessel (S102). It is herein assumed that, in the second example embodiment, the vessel information may be stored in the data accumulation unit 20 in a state where the navigation state of, time information on and velocity information on the corresponding vessel are associated with one another. The data obtaining unit 301 extracts data on temporally continuous navigation states of, pieces of position information on and pieces of velocity information on each vessel, from the data accumulation unit 20. The data obtaining unit 301 outputs the data indicating the navigation states, the position information, and the velocity information to the track pattern generation unit 302.

Note that typically, the vessel information obtained from GPS or AIS may include the velocity information. However, if the vessel information does not include the velocity information, the data obtaining unit 301 can calculate the velocity from the spatial distance and temporal distance between continuous two points. The temporal distance can be obtained from the dates and times of obtaining data items on continuous two points.

The track pattern generation unit 302 generates the track pattern for each piece of the vessel information, using the position information on the vessel (S104). Specifically, the track pattern generation unit 302 determines a drawing method on the basis of the velocity information, and generates the track pattern image that is drawn by interpolating discrete pieces of position information. That is, the track pattern generation unit 302 generates the track patterns so as to draw the tracks by representation methods different depending on velocities of the vessels in the tracks. The track pattern generation unit 302 then sets a navigation state (correct navigation state) corresponding to the track pattern image as a correct label of the track pattern, in the data on the navigation states obtained from the data obtaining unit 301. The track pattern generation unit 302 then outputs the generated track pattern image, and label information indicating the correct label, to the pattern learning unit 303. A more specific method of generating the track pattern according to the second example embodiment is described later.

The pattern learning unit 303 learns the track patterns, and generates learned parameters (S106). Specifically, the pattern learning unit 303 learns the track pattern image, on the basis of the track pattern image and the label information output from the track pattern generation unit 302, optimizes the parameters of the navigation state classifier, and generates the learned parameters. The pattern learning unit 303 then stores the optimized parameters (learned parameters) in the parameter accumulation unit 30.

Hereinafter, a method of generating the track pattern from the position information and the velocity information according to the second example embodiment is described. Note that the process of generating the track from the position information is substantially similar to the process of the track pattern generation unit 102. Accordingly, the description is omitted. Hereinafter, a method of determining the track drawing method on the basis of the velocity information after completion of drawing of the track pattern image in FIG. 7 is described. That is, in the second example embodiment, the velocity information is superimposed on the track (track pattern) generated from the position information.

First, the track pattern generation unit 302 converts the velocity information vᵢ using a predetermined maximum velocity vₘₐₓ by the following Equation 3, and calculates vᵢ′ normalized in a range from 0.0 to 1.0. Note that about 45 knots, which is a current actual maximum velocity of a high-speed vessel, may be input as vₘₐₓ. Alternatively, 22 knots (Japan), 24 knots (Europe), and 30 knots (U.S.) may be adopted as vₘₐₓ, using definitions of high-speed vessels in the respective countries.

$$\begin{matrix}[ Expression 3 ] & \\ {v}_{i}^{′} = \{ \begin{matrix}{v}_{i} / {v}_{max} & {v}_{i} \leq {v}_{max} \\ 1. & otherwise\end{matrix} & ( Equation 3 )\end{matrix}$$

The track pattern generation unit 302 determines the drawing method for the track pattern image in FIG. 7 on the basis of the value vᵢ′. For example, the color of a drawing line may be changed on the basis of vᵢ′. As for the method of changing the color of the line on the basis of vᵢ′, mapping of vᵢ′ on a hue circle is described. If mapping is performed such that the minimum value and the maximum value of v′ are at 0 and 360 degrees on the hue circle, respectively, the maximum value and the minimum value of the velocity are continuous on the hue circle. Accordingly, for example, vᵢ′ may be mapped onto the hue circle such that the minimum value corresponds to 0-degree (red) hue, and the maximum value corresponds to 240-degree (blue) hue. Here, the hue Hᵢ is represented by the following Equation 4.

(Equation 4)

Hᵢ=240/360×vᵢ′ [Expression 4]

As described above, color information (color value) on the HSV space in which the velocity information on the vessel is reflected is represented by the following Equation 5.

(Equation 5)

Cᵢ^{HSV}=[Hᵢ,1.0,1.0] [Expression 5]

Finally generated color information on the RGB space is represented by the following Equation 6.

(Equation 6)

Cᵢ^{RGB}=f_{HSV2RGB}(Cᵢ^{HSV}) [Expression 6]

Note that f_{HSV2RGB}(•) represents a conversion function from the HSV color space into the RGB color space.

As described above, in the second example embodiment, the track pattern (trajectory) shown in FIG. 7 is colored on the basis of the velocity information on the vessel. That is, the coloring color of the track pattern is uniquely determined depending on the velocity information on the vessel. Note that Cᵢ^{RGB} may be used as the color at a point pᵢ. On the other hand, the color of a line segment connecting the point pᵢ and the point p₍ᵢ₊₁₎ may be determined by weighting so as to linearly change the color between the two points. Alternatively, the color of a mean value of the pieces of color information corresponding to the pieces of velocity information at the point pᵢ and the point p₍ᵢ₊₁₎, or the color at any one of these points may be simply used.

Note that the drawing method changed on the basis of vᵢ′ is not limited to what represents the velocity information using the color. For example, the velocity information may be represented by the thickness or the type of the line to be drawn (a broken line, dotted line, etc.) or the like. Note that in the case of the drawing method using the color, a three-channel track pattern image can be generated. In the case of the drawing method using the type or thickness of the line, a one-channel track pattern image can be generated.

As described above, the track pattern generation unit 302 sets the navigation state s_{T} at the time point T as the correct label, for the navigation states corresponding to the track pattern image generated centered at the reference time point T. By repeating the processes described above for any vessel at any time point, a large amount of correctly labelled image datasets can be generated.

Similar to the pattern learning unit 103, the pattern learning unit 303 generates learned parameters, using a typical supervised classifier, through supervised machine learning, from the large amount of correctly labelled image datasets generated by the track pattern generation unit 302. For example, the pattern learning unit 303 may perform learning using the convolutional neural network (CNN). If color is used for the track drawing method, input of the CNN is changed from a gray-scale image to a color image. Accordingly, it should be noted that the channel configuration of the network is different from that in the first example embodiment.

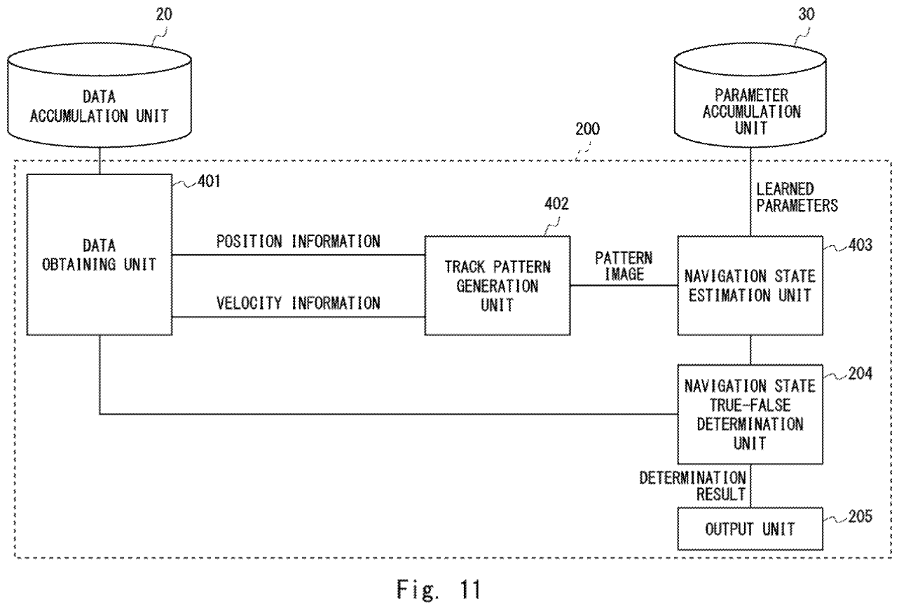

FIG. 11 shows the configuration of the vessel analysis device 200 according to the second example embodiment. Note that the overview of the vessel analysis method executed by the vessel analysis device 200 according to the second example embodiment is substantially similar to that in the flowchart shown in FIG. 9. The vessel analysis device 200 according to the second example embodiment includes a data obtaining unit 401, a track pattern generation unit 402, a navigation state estimation unit 403, a navigation state true-false determination unit 204, and an output unit 205. The data obtaining unit 401 functions as data obtaining means. The track pattern generation unit 402 functions as track pattern generation means (second pattern generation means). The navigation state estimation unit 403 functions as navigation state estimation means. The track pattern generation unit 402 corresponds to the pattern generation unit 2 shown in FIG. 1. The navigation state estimation unit 403 corresponds to the estimation unit 4 shown in FIG. 1.

The data obtaining unit 401 obtains vessel information on an intended vessel (S122). Here, as described above, in the second example embodiment, the vessel information is stored in the data accumulation unit 20 in a state where the navigation state of, time information on and velocity information on the corresponding vessel are associated with one another. The data obtaining unit 401 extracts data on temporally continuous navigation states of, pieces of position information on and pieces of velocity information on a vessel to be analyzed (intended vessel) from the data accumulation unit 20. The data obtaining unit 401 outputs the position information and the velocity information to the track pattern generation unit 402. The data obtaining unit 401 outputs data indicating the navigation state to the navigation state true-false determination unit 204. As described above, it is herein assumed that the navigation states obtained (extracted) in the process of S122 are possibly falsified. Similar to the data obtaining unit 301, the data obtaining unit 401 can calculate the velocity from the spatial distance and temporal distance between continuous two points if the vessel information does not include the velocity information.

The track pattern generation unit 402 generates an intended track pattern that is a track pattern representing the track of the intended vessel (S124). Specifically, the track pattern generation unit 402 determines the drawing method (color or the like) on the basis of the velocity information, generates a track pattern image (intended track pattern image) that is drawn by interpolating discrete pieces of position information on the basis of the position information output from the data obtaining unit 401. That is, the track pattern generation unit 402 generates an intended track pattern so as to draw a track by the representation method different depending on the velocity of the intended vessel in the track. Note that the details of generation of the intended track pattern image is substantially similar to the process of the track pattern generation unit 302 (S104) except in that the process of setting the label corresponding to the track pattern is not included. Accordingly, the detailed description is omitted. The track pattern generation unit 402 then outputs the generated intended track pattern image to the navigation state estimation unit 403.

The navigation state estimation unit 403 estimates the navigation state of the intended vessel (S126). Specifically, the navigation state estimation unit 403 obtains parameters of the navigation state classifier having already been learned (learned parameters) from the parameter accumulation unit 30. The navigation state estimation unit 403 reconstructs a navigation state classifier having the same configuration as the navigation state classifier learned by the pattern learning unit 303. The navigation state estimation unit 403 estimates the navigation state of the intended vessel from the intended track pattern image output from the track pattern generation unit 402. The navigation state estimation unit 403 outputs the navigation state having been estimated (estimated navigation state) to the navigation state true-false determination unit 204.

Similar to the first example embodiment, the navigation state true-false determination unit 204 compares the navigation state (intended navigation state) indicated in the vessel information on the intended vessel output from the data obtaining unit 401 with the estimated navigation state output from the navigation state estimation unit 403 (S128). The navigation state true-false determination unit 204 then determines whether the intended navigation state coincides with the estimated navigation state or not (S130). If both the states coincide with each other (YES in S130), the output unit 205 displays that the intended navigation state is correct (S132). On the other hand, if both the states do not coincide with each other (NO in S130), the output unit 205 displays that the intended navigation state is falsified (S134).

As described above, the vessel analysis system 10 according to the second example embodiment learns, as a set, the track pattern which has been generated from the position information in the vessel information and on which the velocity information has been superimposed, and the navigation state. During an actual operation, the vessel analysis system 10 according to the second example embodiment compares the navigation state estimated from the track pattern which has been generated from the position information in the vessel information on the intended vessel and on which the velocity information has been superimposed, with the navigation state of the vessel information on the intended vessel, and determines whether the navigation state is true or false. As described above, in the second example embodiment, by superimposing the vessel velocity information on the track pattern, the amount of information is increased. Thus, the vessel analysis system 10 according to the second example embodiment can more accurately determine whether the navigation state in the vessel information on the intended vessel is falsified or not than the first example embodiment. Consequently, the vessel analysis system 10 (vessel analysis device 200) according to the second example embodiment can more appropriately determine a suspicious vessel than the first example embodiment. The vessel behavior learning device 100 of the vessel analysis system 10 according to the second example embodiment can generate learned parameters that can more accurately determine whether the navigation state in the vessel information on the intended vessel is falsified or not, in comparison with the first example embodiment.

Consequently, the second example embodiment can generate learned parameters that can more appropriately determine a suspicious vessel, in comparison with the first example embodiment.

### Third Example Embodiment

Next, a third example embodiment is described with reference to the drawings. To clarify the illustration, items of the following description and drawings are appropriately omitted and simplified. In each drawing, the same elements are assigned the same symbols, and redundant description is omitted as required. Note that the system configuration according to the third example embodiment is substantially similar to that shown in FIG. 2. Accordingly, the description is omitted. In the third example embodiment, the track pattern generation method is different from that in the example embodiments described above.

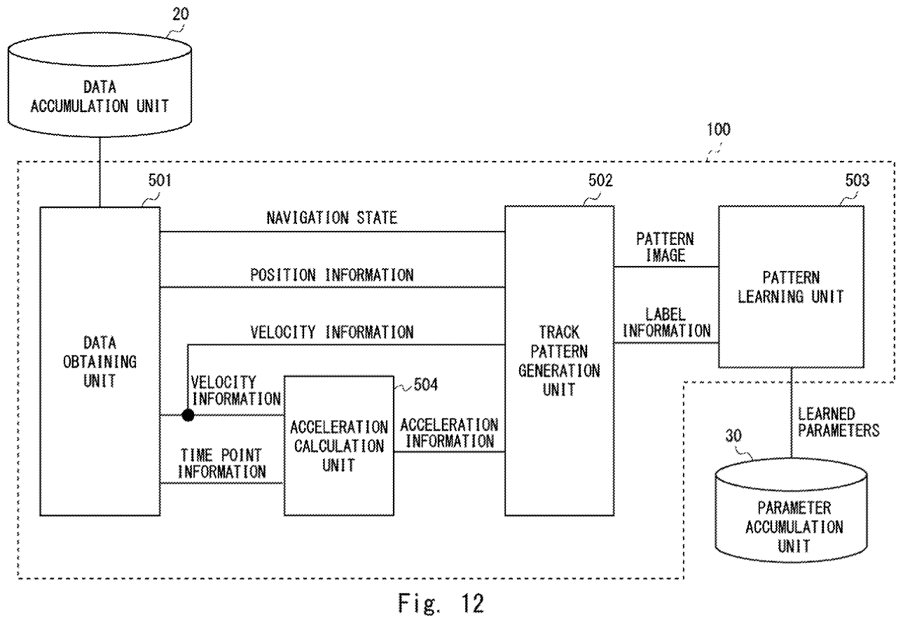

FIG. 12 shows the configuration of a vessel behavior learning device 100 according to the third example embodiment. Note that the overview of the vessel behavior learning method executed by the vessel behavior learning device 100 according to the third example embodiment is substantially similar to that in the flowchart shown in FIG. 4. The vessel behavior learning device 100 according to the third example embodiment includes a data obtaining unit 501, a track pattern generation unit 502, a pattern learning unit 503, and an acceleration calculation unit 504. The data obtaining unit 501 functions as data obtaining means. The track pattern generation unit 502 functions as track pattern generation means (first pattern generation means). The pattern learning unit 503 functions as pattern learning means. The acceleration calculation unit 504 functions as acceleration calculation means.

The data obtaining unit 501 obtains vessel information on each vessel (S102). It is herein assumed that, in the third example embodiment, the vessel information may be stored in the data accumulation unit 20 in a state where the navigation state of, time information on, and velocity information on the corresponding vessel are associated with one another. The data obtaining unit 501 extracts data on temporally continuous navigation states of, pieces of position information on and pieces of velocity information on each vessel from the data accumulation unit 20. The data obtaining unit 501 outputs the data indicating the navigation states, the position information and the velocity information to the track pattern generation unit 502. Furthermore, the data obtaining unit 501 outputs the velocity information and time point information to the acceleration calculation unit 504.

Note that typically, the vessel information obtained from GPS or AIS may include the velocity information. However, if the vessel information does not include the velocity information, the data obtaining unit 501 can calculate the velocity from the spatial distance and temporal distance between continuous two points. The temporal distance can be obtained from the dates and times of obtaining data items on continuous two points.

The acceleration calculation unit 504 calculates the acceleration information from the time point information and the velocity information output from the data obtaining unit 501. The acceleration calculation unit 504 then outputs the calculated acceleration information to the track pattern generation unit 502. Specifically, the acceleration calculation unit 504 uses the temporally continuous pieces of velocity information vᵢ and time points tᵢ at which the respective pieces of velocity information are observed to calculate accelerations aᵢ at the time points by the following Equation 7.

$$\begin{matrix}[ Expression 7 ] & \\ {a}_{i} = \frac{{v}_{i + 1} - {v}_{i}}{{t}_{i + 1} - {t}_{i}} & ( Equation 7 )\end{matrix}$$

The track pattern generation unit 502 generates the track pattern for each piece of the vessel information, using the position information on the vessel (S104). Specifically, the track pattern generation unit 502 determines a drawing method on the basis of the velocity information and the acceleration information, and generates the track pattern image that is drawn by interpolating discrete pieces of position information. The track pattern generation unit 502 then sets a navigation state (correct navigation state) corresponding to the track pattern image as a correct label of the track pattern, in the data on the navigation states obtained from the data obtaining unit 501. The track pattern generation unit 502 then outputs the generated track pattern image, and label information indicating the correct label, to the pattern learning unit 503. A more specific method of generating the track pattern according to the third example embodiment is described later.

The pattern learning unit 503 learns the track patterns, and generates learned parameters (S106). Specifically, the pattern learning unit 503 learns the track pattern image, on the basis of the track pattern image and the label information output from the track pattern generation unit 502, optimizes the parameters of the navigation state classifier, and generates the learned parameters. The pattern learning unit 503 then stores the optimized parameters (learned parameters) in the parameter accumulation unit 30.

Hereinafter, a method of generating the track pattern from the position information, the velocity information and the acceleration information according to the third example embodiment is described. The process of generating the track from the position information, and the process of superimposing the velocity information on the track are substantially similar to the processes of the track pattern generation unit 302. Accordingly, the description is omitted. Hereinafter, a method of determining the track drawing method on the basis of the acceleration information after completion of drawing of the track pattern image in FIG. 7 is described. That is, in the third example embodiment, the acceleration information is superimposed on the track generated from the position information. Note that in the third example embodiment, the track on which the velocity information is superimposed according to the second example embodiment and the track on which the acceleration information is superimposed may be separately generated, or the acceleration information may be further superimposed on the track on which the velocity information has been superimposed according to the second example embodiment.

First, the track pattern generation unit 502 converts the acceleration information aᵢ using a predetermined maximum acceleration aₘₐₓ by the following Equation 8, and calculates aᵢ′ normalized in a range from 0.0 to 1.0. Note that aₘₐₓ may be a predetermined value preset by the user.

$$\begin{matrix}[ Expression 8 ] & \\ {a}_{i}^{′} = \{ \begin{matrix}{a}_{i} / {a}_{max} & {a}_{i} \leq {a}_{max} \\ 1. & otherwise\end{matrix} & ( Equation 8 )\end{matrix}$$

The track pattern generation unit 502 determines the drawing method for the track pattern image in FIG. 7 on the basis of the value aᵢ′. For example, the color of a drawing line may be changed on the basis of aᵢ′. As for the method of changing the color of the line on the basis of aᵢ′, mapping of aᵢ′ onto a hue circle is described. If mapping is performed such that the minimum value and the maximum value of aᵢ′ are at 0 and 360 degrees on the hue circle, respectively, the maximum value and the minimum value of the acceleration are continuous on the hue circle. Accordingly, for example, aᵢ′ may be mapped onto the hue circle such that the minimum value corresponds to 0-degree (red) hue, and the maximum value corresponds to 240-degree (blue) hue. Here, the hue Hᵢ is represented by the following Equation 9.

(Equation 9)

Hᵢ=240/360×αᵢ′ [Expression 9]

As described above, color information (color value) on the HSV space in which the acceleration information on the vessel is reflected is represented by the following Equation 10.

(Equation 10)

Cᵢ^{HSV}=[Hᵢ,1.0,1.9] [Expression 10]

Finally generated color information in the RGB space is represented by the following Equation 11.

(Equation 11)

Cᵢ^{RGB}=f_{HSV2RGB}(Cᵢ^{HSV}) [Expression 11]

Note that f_{HSV2RGB}(•) represents a conversion function from the HSV color space into the RGB color space.

As described above, in the third example embodiment, the track pattern (trajectory) shown in FIG. 7 is colored on the basis of the acceleration information on the vessel. That is, the coloring color of the track pattern is uniquely determined depending on the acceleration information on the vessel. Note that Cᵢ^{RGB} may be used as the color of a line segment connecting the point pᵢ and the point p₍ᵢ₊₁₎. On the other hand, color information corresponding to the mean value of the acceleration a₍ᵢ₋₁₎ calculated at the point p₍ᵢ₋₁₎ and the acceleration aᵢ calculated at the point pᵢ may be used for the color at the point pᵢ. Alternatively, color information corresponding to the acceleration a₍ᵢ₋₁₎ calculated at the point p₍ᵢ₋₁₎, or the acceleration aᵢ at the point pᵢ may be simply used.

Note that the drawing method changed on the basis of aᵢ′ is not limited to what represents the acceleration information using the color. For example, the acceleration information may be represented by the thickness or the type of the line to be drawn (a broken line, dotted line, etc.) or the like. Note that in the case of the drawing method using the color, a three-channel track pattern image can be generated. In the case of the drawing method using the type or thickness of the line, a one-channel track pattern image can be generated.

The track pattern generation unit 502 outputs the two types of track pattern images to the pattern learning unit 503; the track pattern images have been generated as described above, and are the track pattern for which the drawing method is determined according to the velocity, and the track pattern for which the drawing method is determined according to the acceleration. Note that in the case where both the velocity-based drawing method and the acceleration-based drawing method are according to the color, the track pattern generation unit 502 outputs the velocity-based track pattern and the acceleration-based track pattern, as a six-channel track pattern image, to the pattern learning unit 503.

Note that for example, the velocity-based drawing method may be according to the color, and the acceleration-based drawing method may be according to the thickness of the line. In this case, the track pattern generation unit 502 outputs the velocity-based track pattern and the acceleration-based track pattern, as a four-channel track pattern image, to the pattern learning unit 503. For example, the velocity-based drawing method may be according to the type of the line, and the acceleration-based drawing method may be according to the thickness of the line. In this case, the track pattern generation unit 502 outputs the velocity-based track pattern and the acceleration-based track pattern, as a two-channel track pattern image, to the pattern learning unit 503.

Similar to the pattern learning unit 103, the pattern learning unit 503 generates learned parameters, using a typical supervised classifier, through supervised machine learning, from the large amount of correctly labelled image datasets generated by the track pattern generation unit 502. For example, the pattern learning unit 503 may perform learning using the convolutional neural network (CNN).

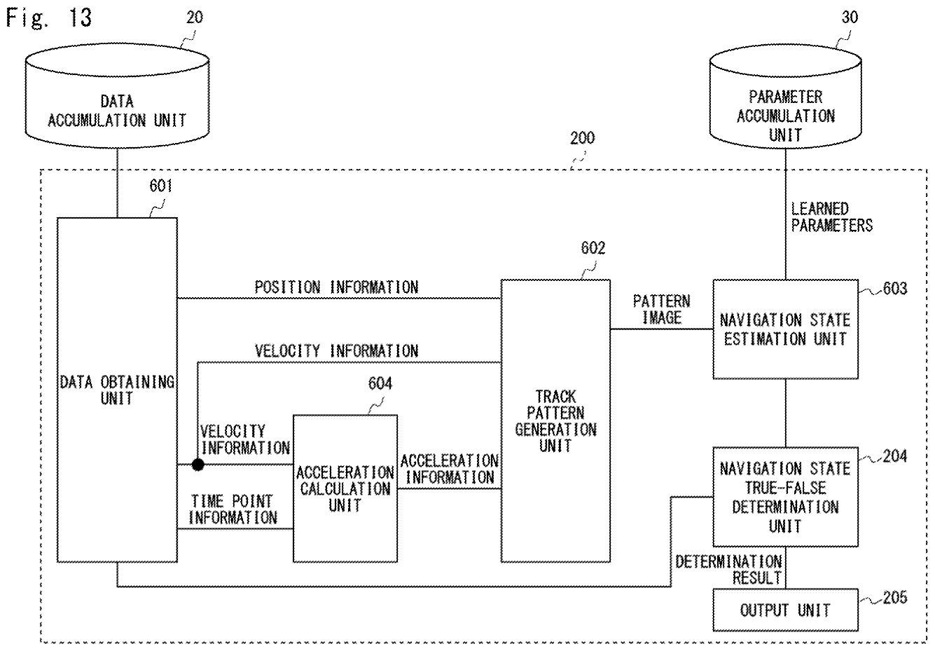

FIG. 13 shows the configuration of the vessel analysis device 200 according to the third example embodiment. Note that the overview of the vessel analysis method executed by the vessel analysis device 200 according to the third example embodiment is substantially similar to that in the flowchart shown in FIG. 9. The vessel analysis device 200 according to the third example embodiment includes a data obtaining unit 601, a track pattern generation unit 602, a navigation state estimation unit 603, an acceleration calculation unit 604, a navigation state true-false determination unit 204, and an output unit 205. The data obtaining unit 601 functions as data obtaining means. The track pattern generation unit 602 functions as track pattern generation means (second pattern generation means). The navigation state estimation unit 603 functions as navigation state estimation means. The track pattern generation unit 602 corresponds to the pattern generation unit 2 shown in FIG. 1. The navigation state estimation unit 603 corresponds to the estimation unit 4 shown in FIG. 1.

The data obtaining unit 601 obtains vessel information on an intended vessel (S122). Here, as described above, in the third example embodiment, the vessel information is stored in the data accumulation unit 20 in a state where the navigation state of, time information on, and velocity information on the corresponding vessel are associated with one another. The data obtaining unit 601 extracts data on temporally continuous navigation states of, pieces of position information on and pieces of velocity information on a vessel to be analyzed (intended vessel) from the data accumulation unit 20. The data obtaining unit 601 outputs the position information and the velocity information to the track pattern generation unit 602. The data obtaining unit 601 outputs data indicating the navigation state to the navigation state true-false determination unit 204. As described above, it is herein assumed that the navigation states obtained (extracted) in the process of S122 are possibly falsified. Similar to the data obtaining unit 301, the data obtaining unit 601 can calculate the velocity from the spatial distance and temporal distance between continuous two points if the vessel information does not include the velocity information.

Furthermore, the data obtaining unit 601 outputs the velocity information and time point information to the acceleration calculation unit 604. Similar to the acceleration calculation unit 504, the acceleration calculation unit 604 calculates the acceleration information from the time point information and the velocity information output from the data obtaining unit 601. The acceleration calculation unit 604 then outputs the calculated acceleration information to the track pattern generation unit 602.

The track pattern generation unit 602 generates an intended track pattern that is a track pattern representing the track of the intended vessel (S124). Specifically, the track pattern generation unit 602 determines the drawing method (color or the like) on the basis of the velocity information, and generates a track pattern image (intended track pattern image) that is drawn by interpolating discrete pieces of position information on the basis of the position information output from the data obtaining unit 601. Furthermore, the track pattern generation unit 602 determines the drawing method (color or the like) on the basis of the acceleration information, and generates a track pattern image (intended track pattern image) that is drawn by interpolating discrete pieces of position information on the basis of the position information output from the data obtaining unit 601. That is, the track pattern generation unit 602 generates intended track patterns with respect to the velocity and the acceleration so as to draw a track by the representation method different depending on the velocity and the acceleration of the intended vessel in the track. Note that the details of generating the intended track pattern image is substantially similar to the process of the track pattern generation unit 502 (S104) except in that the process of setting the label corresponding to the track pattern is not included. Accordingly, the detailed description is omitted. The track pattern generation unit 602 then outputs the generated intended track pattern image to the navigation state estimation unit 603.

The navigation state estimation unit 603 estimates the navigation state of the intended vessel (S126). Specifically, the navigation state estimation unit 603 obtains parameters of the navigation state classifier having already been learned (learned parameters) from the parameter accumulation unit 30. The navigation state estimation unit 603 reconstructs a navigation state classifier having the same configuration as the navigation state classifier learned by the pattern learning unit 503. The navigation state estimation unit 603 estimates the navigation state of the intended vessel from the intended track pattern image output from the track pattern generation unit 602. The navigation state estimation unit 603 outputs the navigation state having been estimated (estimated navigation state) to the navigation state true-false determination unit 204.

Similar to the first example embodiment, the navigation state true-false determination unit 204 compares the navigation state (intended navigation state) indicated in the vessel information on the intended vessel output from the data obtaining unit 601 with the estimated navigation state output from the navigation state estimation unit 603 (S128). The navigation state true-false determination unit 204 then determines whether the intended navigation state coincides with the estimated navigation state or not (S130). If both the states coincide with each other (YES in S130), the output unit 205 displays that the intended navigation state is correct (S132). On the other hand, if both the states do not coincide with each other (NO in S130), the output unit 205 displays that the intended navigation state is falsified (S134).

As described above, the vessel analysis system 10 according to the third example embodiment learns, as a set, the track pattern which has been generated from the position information in the vessel information and on which the velocity information has been superimposed, and the navigation state. Furthermore, the vessel analysis system 10 according to the third example embodiment learns, as a set, the track pattern which has been generated from the position information in the vessel information and on which the acceleration information has been superimposed, and the navigation state. During an actual operation, the vessel analysis system 10 according to the third example embodiment estimates the navigation state, from the track patterns which have been generated from the position information in the vessel information on the intended vessel and on which the velocity information and the acceleration information have been superimposed, respectively. The vessel analysis system 10 according to the third example embodiment compares the estimated navigation state with the navigation state of the vessel information on the intended vessel, and determines whether the navigation state is true or false. As described above, in the third example embodiment, by superimposing the vessel velocity information and the acceleration information on the track pattern, the amount of information is increased.

Thus, the vessel analysis system 10 according to the third example embodiment can more accurately determine whether the navigation state in the vessel information on the intended vessel is falsified or not than the other example embodiments described above. Consequently, the vessel analysis system 10 (vessel analysis device 200) according to the third example embodiment can more appropriately determine a suspicious vessel than the other example embodiments described above. The vessel behavior learning device 100 of the vessel analysis system 10 according to the third example embodiment can generate learned parameters that can more accurately determine whether the navigation state in the vessel information on the intended vessel is falsified or not, in comparison with the other example embodiments described above. Consequently, the third example embodiment can generate learned parameters that can more appropriately determine a suspicious vessel, in comparison with the other example embodiments described above.

### Modified Example

Note that the present invention is not limited to the example embodiments described above, and can be appropriately modified in a range without departing from the spirit. For example, one or more of the processes of steps in the flowcharts described above may be omitted. For example, S132 of FIG. 9 may be omitted.

For example, not only the velocity and the acceleration but also the turning rate of the vessel (the temporal change in the traveling direction) or the like may be used as information that can be used for determining the drawing method in the track pattern generation unit. That is, a method of using the turning rate of the vessel described below may be further applied to the example embodiments described above.

Here, the turning rate may be included in data indicating the navigation state of the vessel information, such as AIS information. In the case of using the turning rate, the track pattern generation units of the vessel behavior learning device 100 and the vessel analysis device 200 normalize the time-series turning rate in a manner similar to that in the case of using the velocity or the acceleration (see Equations 3 and 8). Here, provided that the normalized turning rate is tr′, the track pattern generation unit maps each tr′ onto the hue circle, and determines the color corresponding to the individual tr′. In the case of using the turning rate, it is preferable to regard the difference between 0 and 359 degrees as one degree, for example. Accordingly, unlike the case of using the velocity or the acceleration, Equation 12 may be used to map the hue Hᵢ.

Hᵢ=tr′ (Equation 12)

The track pattern generation unit colors the point pᵢ (see FIG. 7) with, for example, the color corresponding to tr′ at this point, and colors the line segment connecting the point pᵢ and the point pᵢ₊₁ with, for example, the color corresponding to the mean value of tr′ at the point pᵢ and tr′ at the point pᵢ₊₁. Note that the drawing method is not limited to the method of changing the color depending on tr′. For example, the thickness of the line, the type of the line to be drawn or the like may be changed depending on tr′. Similar to the cases in the example embodiments described above, the track pattern generation unit sets the navigation state sᵣ at the time point T as the correct label, for the navigation states corresponding to the track pattern image. Note that also for the vessel analysis device and the vessel analysis method, a process substantially similar to the track pattern generation in the example embodiments described above is performed. Note that track pattern generation in the vessel analysis device and the vessel analysis method is substantially similar except for the track pattern generation unit pertaining to the turning rate described above and for label information assigning. As described above, also in the case of using the turning rate, the amount of information increases. Accordingly, advantageous effects substantially similar to those in the second and third example embodiments can be exerted.

In the examples described above, the program can be stored using any of various types of non-transitory computer readable media, and be provided for the computer. The non-transitory computer-readable media include various types of tangible storage media. Examples of the non-transitory computer-readable media include magnetic recording media (e.g., a flexible disk, a magnetic tape, and a hard disk drive), a magnetooptical recording medium (e.g., a magnetooptical disk), a CD-ROM, a CD-R, a CD-R/W, a semiconductor memories (e.g., a mask ROM, a PROM (Programmable ROM), an EPROM (Erasable PROM), a flash ROM, and a RAM). The program can be supplied to the computer through any of various types of non-transitory computer readable media. Examples of transitory computer-readable media include an electric signal, an optical signal, and electromagnetic waves. The transitory computer-readable media can be supplied to the computer through any of wired communication paths, such as electric wire or an optical fiber, or a wireless communication path.

The invention of the present application has thus been described with reference to the example embodiments. However, the invention of the present application is not limited to the above description. The configuration and details of the invention of the present application can be variously modified within the scope of the invention in a manner allowing those skilled in the art to understand.

A part of or all the example embodiments described above can be described also as the following Supplementary notes, but are not limited to the followings.

### (Supplementary Note 1)

A vessel analysis device, comprising:

pattern generation means for generating an intended track pattern representing a track of an intended vessel that is a vessel to be analyzed, from position information on the intended vessel, the position information changing as time proceeds;

estimation means for estimating a navigation state of the intended vessel, using the generated track pattern; and

determination means for determining whether an intended navigation state that is a navigation state indicated in vessel information originated by the intended vessel is falsified or not by comparing the estimated navigation state with the intended navigation state.

### (Supplementary Note 2)

The vessel analysis device according to Supplementary Note 1, wherein the estimation means estimates the navigation state of the intended vessel, using learned parameters preliminarily generated by machine learning using a plurality of track patterns and correct navigation states that are correct labels corresponding to the respective track patterns.

### (Supplementary Note 3)

The vessel analysis device according to Supplementary Note 1 or 2, wherein the pattern generation means generates the intended track pattern so as to draw the track by a representation method different depending on a velocity of the intended vessel in the track.

### (Supplementary Note 4)

The vessel analysis device according to Supplementary Note 3, wherein the pattern generation means generates the intended track pattern so as to draw the track with a color different depending on the velocity of the intended vessel in the track.

### (Supplementary Note 5)

The vessel analysis device according to any one of Supplementary Notes 1 to 4, wherein the pattern generation means generates the intended track pattern so as to draw the track by a representation method different depending on an acceleration of the intended vessel in the track.

### (Supplementary Note 6)

The vessel analysis device according to Supplementary Note 5, wherein the pattern generation means generates the intended track pattern so as to draw the track with a color different depending on the acceleration of the intended vessel in the track.

### (Supplementary Note 7)

The vessel analysis device according to any one of Supplementary Notes 1 to 6, wherein the pattern generation means generates the intended track pattern so as to draw the track by a representation method different depending on a turning rate of the intended vessel in the track.

### (Supplementary Note 8)

The vessel analysis device according to Supplementary Note 7, wherein the pattern generation means generates the intended track pattern so as to draw the track with a color different depending on the turning rate of the intended vessel in the track.

### (Supplementary Note 9)

A vessel behavior learning device, comprising:

pattern generation means for generating a plurality of track patterns representing tracks of one or more vessels, from position information on the vessels, using vessel information originated from the vessels, the position information changing as time proceeds; and

pattern learning means for generating learned parameters by machine learning using the generated track patterns and correct navigation states that are correct labels corresponding to the respective track patterns.

### (Supplementary Note 10)

The vessel behavior learning device according to Supplementary Note 9, wherein the pattern generation means generates the track patterns so as to draw the tracks by representation methods different depending on velocities of the vessels in the tracks.

### (Supplementary Note 11)

The vessel behavior learning device according to Supplementary Note 10, wherein the pattern generation means generates the track patterns so as to draw the tracks with colors different depending on the velocities of the vessels in the tracks.

### (Supplementary Note 12)

The vessel behavior learning device according to any one of Supplementary Notes 9 to 11, wherein the pattern generation means generates the track patterns so as to draw the tracks by representation methods different depending on accelerations of the vessels in the tracks.

### (Supplementary Note 13)

The vessel behavior learning device according to Supplementary Note 12, wherein the pattern generation means generates the track patterns so as to draw the tracks with colors different depending on the accelerations of the vessels in the tracks.

### (Supplementary Note 14)

The vessel behavior learning device according to any one of Supplementary Notes 9 to 13, wherein the pattern generation means generates the track patterns so as to draw the tracks by representation methods different depending on turning rates of the vessels in the tracks.

### (Supplementary Note 15)

The vessel behavior learning device according to Supplementary Note 14, wherein the pattern generation means generates the track patterns so as to draw the tracks with colors different depending on the turning rates of the vessels in the tracks.

### (Supplementary Note 16)

A vessel analysis system, comprising:

vessel analysis means for analyzing a behavior of a vessel; and

vessel behavior learning means for generating learned parameters used by the vessel analysis means, wherein

the vessel behavior learning means comprises:
first pattern generation means for generating a plurality of track patterns representing tracks of one or more vessels, from position information on the vessels, using vessel information originated from the vessels, the position information changing as time proceeds; and
pattern learning means for generating the learned parameters by machine learning using the track patterns generated by the first pattern generation means, and correct navigation states that are correct labels corresponding to the respective track patterns, and

the vessel analysis means comprises:
second pattern generation means for generating an intended track pattern representing a track of an intended vessel that is a vessel to be analyzed, from position information on the intended vessel, the position information changing as time proceeds;
estimation means for estimating a navigation state of the intended vessel, using the intended track pattern generated by the second pattern generation means, and the learned parameters; and
determination means for determining whether an intended navigation state that is a navigation state indicated in vessel information originated by the intended vessel is falsified or not by comparing the estimated navigation state with the intended navigation state.

### (Supplementary Note 17)

The vessel analysis system according to Supplementary Note 16, wherein

the first pattern generation means generates the track patterns so as to draw the tracks by representation methods different depending on velocities of the vessels in the tracks, and

the second pattern generation means generates the intended track pattern so as to draw the track by a representation method different depending on a velocity of the intended vessel in the track.

### (Supplementary Note 18)

The vessel analysis system according to Supplementary Note 17, wherein

the first pattern generation means generates the track patterns so as to draw the tracks with colors different depending on the velocities of the vessels in the tracks, and

the second pattern generation means generates the intended track pattern so as to draw the track with a color different depending on the velocity of the intended vessel in the track.

### (Supplementary Note 19)

The vessel analysis system according to any one of Supplementary Notes 16 to 18, wherein

the first pattern generation means generates the track patterns so as to draw the tracks by representation methods different depending on accelerations of the vessels in the tracks, and

the second pattern generation means generates the intended track pattern so as to draw the track by a representation method different depending on an acceleration of the intended vessel in the track.

### (Supplementary Note 20)

The vessel analysis system according to Supplementary Note 19, wherein

the first pattern generation means generates the track patterns so as to draw the tracks with colors different depending on the accelerations of the vessels in the tracks, and

the second pattern generation means generates the intended track pattern so as to draw the track with a color different depending on the acceleration of the intended vessel in the track.

### (Supplementary Note 21)

The vessel analysis system according to any one of Supplementary Notes 16 to 20, wherein

the first pattern generation means generates the track patterns so as to draw the tracks by representation methods different depending on turning rates of the vessels in the tracks, and

the second pattern generation means generates the intended track pattern so as to draw the track by a representation method different depending on a turning rate of the intended vessel in the track.

### (Supplementary Note 22)

The vessel analysis system according to Supplementary Note 21, wherein

the first pattern generation means generates the track patterns so as to draw the tracks with colors different depending on the turning rates of the vessels in the tracks, and

the second pattern generation means generates the intended track pattern so as to draw the track with a color different depending on the turning rate of the intended vessel in the track.

### (Supplementary Note 23)

A vessel analysis method, comprising:

generating an intended track pattern representing a track of an intended vessel that is a vessel to be analyzed, from position information on the intended vessel, the position information changing as time proceeds;

estimating a navigation state of the intended vessel, using the generated track pattern; and

determining whether an intended navigation state that is a navigation state indicated in vessel information originated by the intended vessel is falsified or not by comparing the estimated navigation state with the intended navigation state.

### (Supplementary Note 24)

The vessel analysis method according to Supplementary Note 23, the method estimating the navigation state of the intended vessel, using learned parameters preliminarily generated by machine learning using a plurality of track patterns and correct navigation states that are correct labels corresponding to the respective track patterns.

### (Supplementary Note 25)

The vessel analysis method according to Supplementary Note 23 or 24, the method generating the intended track pattern so as to draw the track by a representation method different depending on a velocity of the intended vessel in the track.

### (Supplementary Note 26)

The vessel analysis method according to Supplementary Note 25, the method generating the intended track pattern so as to draw the track with a color different depending on the velocity of the intended vessel in the track.

### (Supplementary Note 27)

The vessel analysis method according to any one of Supplementary Notes 23 to 26, wherein the method generating the intended track pattern so as to draw the track by a representation method different depending on an acceleration of the intended vessel in the track.

### (Supplementary Note 28)

The vessel analysis method according to Supplementary Note 27, wherein the method generating the intended track pattern so as to draw the track with a color different depending on the acceleration of the intended vessel in the track.

### (Supplementary Note 29)

The vessel analysis method according to any one of Supplementary Notes 23 to 28, wherein the method generating the intended track pattern so as to draw the track by a representation method different depending on a turning rate of the intended vessel in the track.

### (Supplementary Note 30)

The vessel analysis method according to Supplementary Note 29, wherein the method generating the intended track pattern so as to draw the track with a color different depending on the turning rate of the intended vessel in the track.

### (Supplementary Note 31)

A vessel behavior learning method, comprising:

generating a plurality of track patterns representing tracks of one or more vessels, from position information on the vessels, using vessel information originated from the vessels, the position information changing as time proceeds; and

generating learned parameters by machine learning using the generated track patterns and correct navigation states that are correct labels corresponding to the respective track patterns.

### (Supplementary Note 32)

The vessel behavior learning method according to Supplementary Note 31, wherein the method generating the track patterns so as to draw the tracks by representation methods different depending on velocities of the vessels in the tracks.

### (Supplementary Note 33)

The vessel behavior learning method according to Supplementary Note 32, wherein the method generating the track patterns so as to draw the tracks with colors different depending on the velocities of the vessels in the tracks.

### (Supplementary Note 34)

The vessel behavior learning method according to any one of Supplementary Notes 31 to 33, wherein the method generating the track patterns so as to draw the tracks by representation methods different depending on accelerations of the vessels in the tracks.

### (Supplementary Note 35)

The vessel behavior learning method according to Supplementary Note 34, wherein the method generating the track patterns so as to draw the tracks with colors different depending on the accelerations of the vessels in the tracks.

### (Supplementary Note 36)

The vessel behavior learning method according to any one of Supplementary Notes 31 to 35, wherein the method generating the track patterns so as to draw the tracks by representation methods different depending on turning rates of the vessels in the tracks.

### (Supplementary Note 37)

The vessel behavior learning method according to Supplementary Note 36, wherein the method generating the track patterns so as to draw the tracks with colors different depending on the turning rates of the vessels in the tracks.

### (Supplementary Note 38)

A non-transitory computer-readable medium storing a program causing a computer to execute:

a step of generating an intended track pattern representing a track of an intended vessel that is a vessel to be analyzed, from position information on the intended vessel, the position information changing as time proceeds;

a step of estimating a navigation state of the intended vessel, using the generated track pattern; and

a step of determining whether an intended navigation state that is a navigation state indicated in vessel information originated by the intended vessel is falsified or not by comparing the estimated navigation state with the intended navigation state.

### (Supplementary Note 39)

A non-transitory computer-readable medium storing a program causing a computer to execute:

a step of generating a plurality of track patterns representing tracks of one or more vessels, from position information on the vessels, using vessel information originated from the vessels, the position information changing as time proceeds; and

a step of generating learned parameters by machine learning using the generated track patterns and correct navigation states that are correct labels corresponding to the respective track patterns.

### REFERENCE SIGNS LIST

1 Vessel analysis device
2 Pattern generation unit
4 Estimation unit
6 Determination unit
10 Vessel analysis system
20 Data accumulation unit
30 Parameter accumulation unit
100 Vessel behavior learning device
101 Data obtaining unit
102 Track pattern generation unit
103 Pattern learning unit
200 Vessel analysis device
201 Data obtaining unit
202 Track pattern generation unit
203 Navigation state estimation unit
204 Navigation state true-false determination unit
205 Output unit
301 Data obtaining unit
302 Track pattern generation unit
303 Pattern learning unit
401 Data obtaining unit
402 Track pattern generation unit
403 Navigation state estimation unit
501 Data obtaining unit
502 Track pattern generation unit
503 Pattern learning unit
504 Acceleration calculation unit
601 Data obtaining unit
602 Track pattern generation unit
603 Navigation state estimation unit
604 Acceleration calculation unit

What is claimed is:

1. A vessel analysis device, comprising:
hardware, including a processor and memory;
pattern generation unit implemented at least by the hardware and configured to generate an intended track pattern representing a track of an intended vessel that is a vessel to be analyzed, from position information on the intended vessel, the position information changing as time proceeds;
estimation unit implemented at least by the hardware and configured to estimate a navigation state of the intended vessel, using the generated track pattern; and
determination unit implemented at least by the hardware and configured to determine whether an intended navigation state that is a navigation state indicated in vessel information originated by the intended vessel is falsified or not by comparing the estimated navigation state with the intended navigation state.

2. The vessel analysis device according to claim 1, wherein the estimation unit estimates the navigation state of the intended vessel, using learned parameters preliminarily generated by machine learning using a plurality of track patterns and correct navigation states that are correct labels corresponding to the respective track patterns.

3. The vessel analysis device according to claim 1, wherein the pattern generation unit generates the intended track pattern so as to draw the track by a representation method different depending on a velocity of the intended vessel in the track.

4. The vessel analysis device according to claim 3, wherein the pattern generation unit generates the intended track pattern so as to draw the track with a color different depending on the velocity of the intended vessel in the track.

5. The vessel analysis device according to claim 1, wherein the pattern generation unit generates the intended track pattern so as to draw the track by a representation method different depending on an acceleration of the intended vessel in the track.

6. The vessel analysis device according to claim 5, wherein the pattern generation unit generates the intended track pattern so as to draw the track with a color different depending on the acceleration of the intended vessel in the track.

7. The vessel analysis device according to claim 1, wherein the pattern generation unit generates the intended track pattern so as to draw the track by a representation method different depending on a turning rate of the intended vessel in the track.

8. The vessel analysis device according to claim 7, wherein the pattern generation unit generates the intended track pattern so as to draw the track with a color different depending on the turning rate of the intended vessel in the track.

9-22. (canceled)

23. A vessel analysis method, comprising:
generating an intended track pattern representing a track of an intended vessel that is a vessel to be analyzed, from position information on the intended vessel, the position information changing as time proceeds;
estimating a navigation state of the intended vessel, using the generated track pattern; and
determining whether an intended navigation state that is a navigation state indicated in vessel information originated by the intended vessel is falsified or not by comparing the estimated navigation state with the intended navigation state.

24. The vessel analysis method according to claim 23, the method estimating the navigation state of the intended vessel, using learned parameters preliminarily generated by machine learning using a plurality of track patterns and correct navigation states that are correct labels corresponding to the respective track patterns.

25. The vessel analysis method according to claim 23, the method generating the intended track pattern so as to draw the track by a representation method different depending on a velocity of the intended vessel in the track.

26. The vessel analysis method according to claim 25, the method generating the intended track pattern so as to draw the track with a color different depending on the velocity of the intended vessel in the track.

27. The vessel analysis method according to claim 23, wherein the method generating the intended track pattern so as to draw the track by a representation method different depending on an acceleration of the intended vessel in the track.

28. The vessel analysis method according to claim 27, wherein the method generating the intended track pattern so as to draw the track with a color different depending on the acceleration of the intended vessel in the track.

29. The vessel analysis method according to claim 23, wherein the method generating the intended track pattern so as to draw the track by a representation method different depending on a turning rate of the intended vessel in the track.

30. The vessel analysis method according to claim 29, wherein the method generating the intended track pattern so as to draw the track with a color different depending on the turning rate of the intended vessel in the track.

31-37. (canceled)

38. A non-transitory computer-readable medium storing a program causing a computer to execute:
a step of generating an intended track pattern representing a track of an intended vessel that is a vessel to be analyzed, from position information on the intended vessel, the position information changing as time proceeds;
a step of estimating a navigation state of the intended vessel, using the generated track pattern; and
a step of determining whether an intended navigation state that is a navigation state indicated in vessel information originated by the intended vessel is falsified or not by comparing the estimated navigation state with the intended navigation state.

39. (canceled)

40. The non-transitory computer-readable medium according to claim 38, the program causing the computer to execute a step of estimating the navigation state of the intended vessel, using learned parameters preliminarily generated by machine learning using a plurality of track patterns and correct navigation states that are correct labels corresponding to the respective track patterns.

41. The non-transitory computer-readable medium according to claim 38, the program causing the computer to execute a step of generating the intended track pattern so as to draw the track by a representation method different depending on a velocity of the intended vessel in the track.

42. The non-transitory computer-readable medium according to claim 41, the program causing the computer to execute a step of generating the intended track pattern so as to draw the track with a color different depending on the velocity of the intended vessel in the track.
